(19) United States
(12) Patent Application Publication
(10) Pub. No.: US 2024/0202108 A1
(43) Pub. Date: Jun. 20, 2024

(54) COMPUTER-IMPLEMENTED METHOD FOR DETERMINING COMPATIBLE SYSTEM ELEMENTS AND SYSTEM

(71) Applicant: dSPACE GmbH, Paderborn (DE)

(72) Inventors: Thomas MISCH, Paderborn (DE); Thomas ZUBERT, Paderborn (DE); Jan Hendrik HAMMER, Paderborn (DE)

(73) Assignee: dSPACE GmbH, Paderborn (DE)

(21) Appl. No.: 18/375,164

(22) Filed: Sep. 29, 2023

(30) Foreign Application Priority Data
Dec. 20, 2022 (DE) 10 2022 134 022.8

(51) Int. Cl. G06F 11/36

(52) U.S. Cl. CPC G06F 11/3688; G06F 11/3664

(57) ABSTRACT

A computer-implemented method and system for determining mutually compatible system elements required for an error-free execution of a virtual test and/or a simulation of a vehicle device and/or a vehicle function, with the steps: providing a parked selection or selecting of at least one first system element required for executing the virtual test and/or the simulation of the vehicle device and/or the vehicle function; determining at least one second system element supporting a compatibility requirement of the first system element; and outputting the determined second system element required for the error-free execution of the virtual test and/or the simulation of the vehicle device and/or the vehicle function and supporting the compatibility requirement of the first system element.

This nonprovisional application claims priority under 35 U.S.C. § 119(a) to German Patent Application No. 10 2022 134 022.8, which was filed in Germany on Dec. 20, 2022, and which is herein incorporated by reference.

### BACKGROUND OF THE INVENTION

### Field of the Invention

The present invention relates to a computer-implemented method for determining mutually compatible system elements required for an error-free execution of a virtual test and/or a simulation of a vehicle device and/or a vehicle function.

The invention relates further to a system for determining mutually compatible system elements required for an error-free execution of a virtual test and/or a simulation of a vehicle device and/or a vehicle function.

Furthermore, the invention relates to a computer-implemented method for executing a virtual test and/or a simulation of a vehicle device and/or a vehicle function using mutually compatible system elements determined by the method of the invention. Furthermore, the invention relates to a computer program and a computer-readable data carrier.

### Description of the Background Art

Vehicle devices such as, for example, control units, and/or a vehicle function such as, e.g., driving assistance functions can be verified or validated using various testing methods. In this regard, virtual tests can be used, in particular.

Sensor data obtained, for example, from test drives and/or otherwise are required for the creation of virtual tests and/or simulations.

To execute a test, different system elements are required in addition to the test itself. These may include, for example, a system to be tested, a test environment, and a test system.

The system to be tested describes an element to be tested, e.g., ECU software. The test environment describes the environment in which the system to be tested is tested and the test system describes the system on which the test is performed. Examples of the test system are HIL or SIL systems, which can be executed, e.g., on an execution node in the cloud.

Because there are usually different or a number of systems to be tested, test environments, and test systems, the situation may arise that not every combination is desired or even possible.

In the event of a test misconfiguration, in which, for example, an incompatible combination of a system to be tested, test environment, and test system is used, this may result in a faulty test execution in connection with a test termination. This unnecessarily ties up computing time and/or computing resources and causes avoidable costs.

However, existing systems for defining dependencies or for finding mutually compatible elements in the context of executing a virtual test and/or a simulation of a vehicle device and/or a vehicle function have the problem that they only offer costly options for searching for matching system elements.

Potentially all system elements of a system are always included in the configuration. When selecting dependent elements, the user himself must therefore know or recognize which of the available elements are compatible, if necessary on the basis of a predefined compatibility model.

### SUMMARY OF THE INVENTION

It is therefore an object of the present invention to improve existing methods for configuring an execution of a virtual test and/or a simulation of a vehicle device and/or a vehicle function in order to avoid faulty test executions and/or simulation executions due to misconfigurations.

The object is achieved according to the invention by a computer-implemented method for determining mutually compatible system elements required for an error-free execution of a virtual test and/or a simulation of a vehicle device and/or a vehicle function.

The object is achieved further according to the invention by a system for determining mutually compatible system elements required for an error-free execution of a virtual test and/or a simulation of a vehicle device and/or a vehicle function.

Moreover, the object is achieved by a computer program and by a computer-readable data carrier.

The invention relates to a computer-implemented method for determining mutually compatible system elements required for an error-free execution of a virtual test and/or a simulation of a vehicle device and/or a vehicle function.

The method comprises providing a parked selection or selecting of at least one first system element required for executing the virtual test and/or the simulation of the vehicle device and/or the vehicle function.

A parked selection can be understood to mean that a user selects beforehand all the system elements required for executing the virtual test and/or the simulation of the vehicle device and/or the vehicle function, and this selection is then provided as a data set.

The method further comprises determining at least one second system element supporting a compatibility requirement of the first system element.

Furthermore, the method comprises outputting the determined second system element required for the error-free execution of the virtual test and/or the simulation of the vehicle device and/or the vehicle function and supporting the compatibility requirement of the first system element.

The skilled person understands the providing, determining, and/or outputting of a system element as the providing, determining, and/or outputting of data representing the system element.

The invention relates further to a system for determining mutually compatible system elements required for an error-free execution of a virtual test and/or a simulation of a vehicle device and/or a vehicle function.

The system comprises a provision unit configured to provide a parked selection or selecting of at least one first system element required executing the virtual test and/or the simulation of the vehicle device and/or the vehicle function.

Furthermore, the system comprises a computing unit configured to determine at least one second system element supporting a compatibility requirement of the first system element.

The system further comprises an output unit configured to output the determined second system element required for the error-free execution of the virtual test and/or the simulation of the vehicle device and/or the vehicle function and supporting the compatibility requirement of the first system element.

The invention further relates to a computer-implemented method for executing a virtual test and/or a simulation of a vehicle device and/or a vehicle function using mutually compatible system elements determined by the method of the invention.

For example, the computer-implemented method for executing the virtual test and/or the simulation of the vehicle device and/or the vehicle function can be executed on an execution node in the cloud.

The vehicle function validated by the virtual test and/or simulated by the simulation method can, for example, be executed on a control unit of the motor vehicle.

The invention additionally relates to a computer program with a program code to perform the method of the invention when the computer program is executed on a computer and to a computer-readable data carrier with the program code of a computer program to perform the method of the invention when the computer program is executed on a computer.

An idea of the invention is to enable a compatibility between the first system element and the second system element by determining the at least one second system element supporting the compatibility requirement of the first system element.

Thus, an error-free execution of mutually compatible system elements required for the virtual test and/or the simulation of the vehicle device and/or the vehicle function can be achieved in an advantageous manner.

System element data stored in a data memory may be provided, wherein each system element can have at least one compatibility requirement and/or at least one compatibility attribute.

In this regard, the compatibility requirement of a respective system element refers to a compatibility attribute of another system element.

Conversely, the compatibility attribute of an existing system element refers to the compatibility requirement of another system element.

The first system element can be compatible with the second system element if the compatibility requirement of the first system element matches a compatibility attribute of the second system element.

Thus, it is advantageously ensured that the first system element is compatible with the second system element, which makes possible an error-free execution of the virtual test and/or the simulation of the vehicle device and/or the vehicle function.

According to an example, it is provided that, in order to determine the at least one second system element supporting the compatibility requirement of the first system element, the data memory can be queried for compatibility attributes of further system elements, which attributes fulfill the compatibility requirement of the first system element.

Thus, all system element data contained in the data memory are queried for compatibility attributes of other system elements, which attributes support the compatibility requirement of the first system element. All further system elements compatible with the first system element can be identified in this way. From this subset of all system elements, a configuration of the virtual test and/or the simulation can then be performed.

The first system element may impose a plurality of different compatibility requirements on the second system element and/or a plurality of further system elements.

The first system element can have any number of different compatibility requirements to be met by other system elements. Depending on whether, for example, a virtual test or a simulation is performed, the compatibility requirements of one system element for the other system elements can differ.

The first system element may impose the at least one compatibility requirement on the second system element, directly connected to the first system element, and/or on a third system element, indirectly connected to the first system element via the second system element.

As a result, dependencies between different system elements that depend on a common, previously stored system element can be taken into account in an advantageous manner.

Further, upon providing the parked selection of the at least one first system element required for executing the virtual test and/or the simulation of the vehicle device and/or the vehicle function, a compatibility check of the parked selection can be performed, wherein an error message is generated when at least one incompatibility of system elements is detected.

Thus, the user can advantageously be informed about an incompatibility of the configuration of system elements before starting the virtual test and/or the simulation.

The compatibility check can comprise determining whether the compatibility attributes of all parked selected system elements satisfy the compatibility requirements of all parked selected system elements.

The compatibility check thus makes it possible to identify a faulty configuration. Further, this makes it possible to determine which system element of a possible plurality of system elements has a faulty configuration, which can reduce an effort for troubleshooting or reconfiguration.

The virtual test can be a model-in-the-loop test, a software-in-the-loop test, a processor-in-the-loop test, or a hardware-in-the-loop test of the vehicle device and/or the vehicle function, and wherein the simulation simulates a behavior of the vehicle device and/or the vehicle function.

The virtual test thus can have a diverse range of applications. The vehicle device may be, e.g., a control unit of any vehicle component such as, for example, a braking system, a steering system, an infotainment system, a communication system, and/or a driving assistance system. Analogously to this, the vehicle function can be a corresponding function that is executed on the corresponding control unit mentioned above.

The system elements can represent a system to be tested, a test environment, a test system, a test type, and/or a test of the vehicle device and/or the vehicle function, a vehicle type to be tested, and/or a vehicle to be tested.

The boundary conditions for testing any vehicle device and/or vehicle function can be defined thereby.

The compatibility requirement and/or the compatibility attribute may refer to a specific system element and/or to a specific property of a system element.

The compatibility requirement of a system element here can refer to the compatibility attribute of another system element. Further, the compatibility attribute of a system element can refer to a compatibility requirement of another system element.

The features described herein of the computer-implemented method for determining mutually compatible system elements required for an error-free execution of a virtual test and/or a simulation of a vehicle device and/or a vehicle function are equally applicable to the system for determining mutually compatible system elements required for an error-free execution of a virtual test and/or a simulation of a vehicle device and/or a vehicle function, and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a flowchart of a computer-implemented method for determining mutually compatible system elements required for an error-free execution of a virtual test and/or a simulation of a vehicle device and/or a vehicle function according to an example of the invention; and

FIG. 2 is a schematic illustration of a system for determining mutually compatible system elements required for an error-free execution of a virtual test and/or a simulation of a vehicle device and/or a vehicle function according to an example.

### DETAILED DESCRIPTION

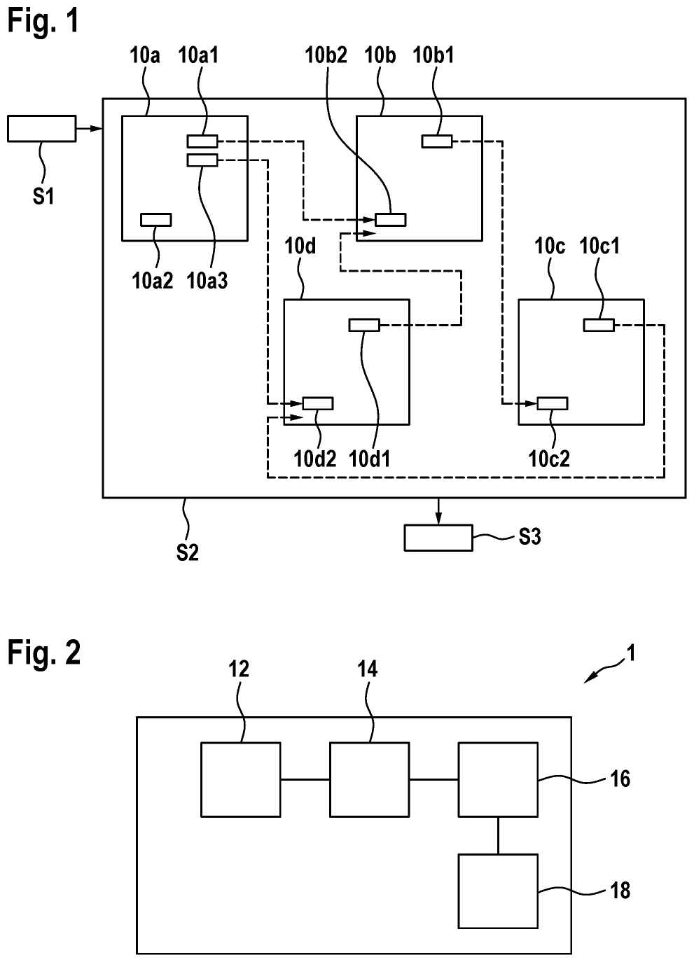

The method shown in FIG. 1 comprises providing S1 a parked selection or selecting of at least one first system element 10a required for executing the virtual test and/or the simulation of the vehicle device and/or the vehicle function.

The virtual test can be, for example, a test for an autonomous driving function. In this context, the test type can be given by, for example, a scenario-based test, a data replay test, and/or a step-based test.

Further, the virtual test can alternatively be a test of any vehicle component such as a battery management system of an electric vehicle or a plug-in hybrid vehicle.

Moreover, the virtual test and/or simulation can be, for example, applications such as rapid control prototyping, control unit measurement, application, and diagnosis, and access to bus systems (CAN, CAN FD, LIN, Ethernet).

Furthermore, the method comprises determining S2 at least one second system element 10b supporting a compatibility requirement of the first system element 10a.

The method additionally comprises outputting S3 the determined second system element 10b required for the error-free execution of the virtual test and/or the simulation of the vehicle device and/or the vehicle function and supporting the compatibility requirement of the first system element 10a.

A data memory 12 provides a plurality of system element data D, wherein each system element has at least one compatibility requirement and/or at least one compatibility attribute.

The first system element 10a is thereby compatible with the second system element if the compatibility requirement of the first system element 10a matches a compatibility attribute of the second system element 10b.

For determining the at least one second system element 10b supporting the compatibility requirement of the first system element 10a, data memory 12 is queried for compatibility attributes of further system elements, which attributes fulfill the compatibility requirement of the first system element 10a.

The first system element can further impose a plurality of different compatibility requirements on the second system element and/or a plurality of other system elements.

The first system element imposes the at least one compatibility requirement on the second system element, directly connected to the first system element, and/or on a third system element, indirectly connected to the first system element via the second system element.

When providing the parked selection of the at least one first system element 10a required for executing the virtual test and/or the simulation of the vehicle device and/or the vehicle function, a compatibility check of the parked selection is further performed. An error message is generated if at least one incompatibility of system elements 10a, 10b, 10c, 10d is detected.

In this case, the compatibility check comprises determining whether the compatibility attributes of all parked selected system elements meet the compatibility requirements of all parked selected system elements.

Further, the virtual test is a model-in-the-loop test, a software-in-the-loop test, a processor-in-the-loop test, or a hardware-in-the-loop test of the vehicle device and/or the vehicle function. The simulation simulates a behavior of the vehicle device and/or the vehicle function.

The system elements represent a system to be tested, a test environment, a test system, a test type, and/or a test of the vehicle device and/or the vehicle function, a vehicle type to be tested, and/or a vehicle to be tested.

Moreover, the compatibility requirement and/or the compatibility attribute relate to a specific system element and/or to a specific property of a system element.

FIG. 2 shows a schematic representation of a system for determining mutually compatible system elements 10a, 10b, 10c, 10d required for an error-free execution of a virtual test and/or a simulation of a vehicle device and/or a vehicle function in accordance with the preferred embodiment of the invention.

The system comprises a provision unit configured to provide a parked selection or selecting of at least one first system element 10a required for executing the virtual test and/or the simulation of the vehicle device and/or the vehicle function.

Furthermore, the system comprises a computing unit configured to determine at least one second system element supporting a compatibility requirement of the first system element 10a.

The system further comprises an output unit configured to output the determined second system element required for the error-free execution of the virtual test and/or the simulation of the vehicle device and/or the vehicle function and supporting the compatibility requirement of the first system element 10a.

Although specific embodiments have been illustrated and described herein, it will be understood by the skilled artisan that there are a number of alternative and/or equivalent implementations. It should be noted that the exemplary embodiment or exemplary embodiments are examples only and are not intended to restrict the scope, applicability, or configuration in any way.

Rather, the foregoing summary and detailed description provide the skilled artisan with convenient instructions for implementing at least one exemplary embodiment, wherein it is understood that various changes in the functional scope and arrangement of the elements can be made without departing from the scope of the appended claims and their legal equivalents.

In general, this application intends to cover modifications or adaptations or variations of the embodiments presented herein. For example, an order of the method steps can be changed. The method can further be carried out sequentially or in parallel, at least in sections.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A computer-implemented method to determine mutually compatible system elements required for an error-free execution of a virtual test and/or a simulation of a vehicle device and/or a vehicle function, the method comprising:
providing a parked selection or selecting at least one first system element required for executing the virtual test and/or the simulation of the vehicle device and/or the vehicle function;
determining at least one second system element supporting a compatibility requirement of the first system element; and
outputting the determined second system element required for the error-free execution of the virtual test and/or the simulation of the vehicle device and/or the vehicle function and supporting the compatibility requirement of the first system element.

2. The computer-implemented method according to claim 1, wherein system element data stored in a data memory are provided, and wherein each system element has at least one compatibility requirement and/or at least one compatibility attribute.

3. The computer-implemented method according to claim 2, wherein the first system element is compatible with the second system element if the compatibility requirement of the first system element matches a compatibility attribute of the second system element.

4. The computer-implemented method according to claim 2, wherein, in order to determine the at least one second system element supporting the compatibility requirement of the first system element, the data memory is queried for compatibility attributes of further system elements, which attributes fulfill the compatibility requirement of the first system element.

5. The computer-implemented method according to claim 1, wherein the first system element imposes a plurality of different compatibility requirements on the second system element and/or a plurality of further system elements.

6. The computer-implemented method according to claim 1, wherein the first system element imposes the at least one compatibility requirement on the second system element directly connected to the first system element and/or on a third system element indirectly connected to the first system element via the second system element.

7. The computer-implemented method according to claim 1, wherein, upon providing the parked selection of the at least one first system element required for executing the virtual test and/or the simulation of the vehicle device and/or the vehicle function, a compatibility check of the parked selection is performed, and wherein an error message is generated when at least one incompatibility of system elements is detected.

8. The computer-implemented method according to claim 7, wherein the compatibility check comprises determining whether the compatibility attributes of all parked selected system elements satisfy the compatibility requirements of all parked selected system elements.

9. The computer-implemented method according to claim 1, wherein the virtual test is a model-in-the-loop test, a software-in-the-loop test, a processor-in-the-loop test, or a hardware-in-the-loop test of the vehicle device and/or the vehicle function, and wherein the simulation simulates a behavior of the vehicle device and/or the vehicle function.

10. The computer-implemented method according to claim 1, wherein the system elements represent a system to be tested, a test environment, a test system, a test type, and/or a test of the vehicle device and/or the vehicle function, a vehicle type to be tested, and/or a vehicle to be tested.

11. The computer-implemented method according to claim 10, wherein the compatibility requirement and/or the compatibility attribute refer to a specific system element and/or a specific property of a system element.

12. A computer-implemented method for executing a virtual test and/or a simulation of a vehicle device and/or a vehicle function using mutually compatible system elements determined by the method according to claim 1.

13. A system to determine mutually compatible system elements required for an error-free execution of a virtual test and/or a simulation of a vehicle device and/or a vehicle function, the system comprising:
a provision unit to provide a parked selection or selecting of at least one first system element required for executing the virtual test and/or the simulation of the vehicle device and/or the vehicle function;
a computing unit to determine at least one second system element supporting a compatibility requirement of the first system element; and
an output unit configured to output the determined second system element required for the error-free execution of the virtual test and/or the simulation of the vehicle device and/or the vehicle function and supporting the compatibility requirement of the first system element.

14. A computer program with a program code to perform the method according to claim 1, when the computer program is executed on a computer.

15. A computer-readable data carrier with the program code of a computer program to perform the method according to claim 1 when the computer program is executed on a computer.
